(19) United States
(12) Patent Application Publication
(10) Pub. No.: US 2026/0246259 A1
(43) Pub. Date: Aug. 20, 2026

(54) ELECTRICAL ASSEMBLY AND METHOD

(71) Applicant: Lear Corporation, Southfield, MI (US)

(72) Inventors: Carlos Fernandez Pueyo, Reus (ES); Jose Juan Hidalgo, Sant Pere de Ribes (ES); Antoni Ferré Fàbregas, Valls (ES)

(73) Assignee: Lear Corporation, Southfield, MI (US)

(21) Appl. No.: 19/056,251

(22) Filed: Feb. 18, 2025

(51) Int. Cl. H02H 7/18; B60L 3/04; H02H 1/00; H02H 7/26

(52) U.S. Cl. CPC H02H 7/18; B60L 3/04; H02H 1/0007; H02H 7/268; B60L 2240/547

(57) ABSTRACT

An electrical assembly comprising a controller assembly, including: a switch, and an electronic controller electrically connected to the switch; a fuse assembly including a plurality of thermal fuses electrically connectable to a plurality of loads; and a wire electrically connecting the controller assembly with the fuse assembly; wherein the electronic controller is configured to: determine that a current in the wire exceeds a current threshold; determine that a battery voltage is at or below a first voltage threshold; open the switch in accordance with determining that at least one of (i) the current exceeds the current threshold, or (ii) the battery voltage is at or below the first voltage threshold; and close and open the switch to increase a fuse temperature of at least one thermal fuse of the plurality of thermal fuses.

### TECHNICAL FIELD

The present disclosure generally relates to electrical assemblies, including electrical assemblies that can, for example, be utilized in connection with vehicles.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a schematic view generally illustrating an embodiment of an electrical assembly in a vehicle according to teachings of the present disclosure.

FIG. 2 is a flow diagram generally illustrating an embodiment of a method of operating an electrical assembly according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

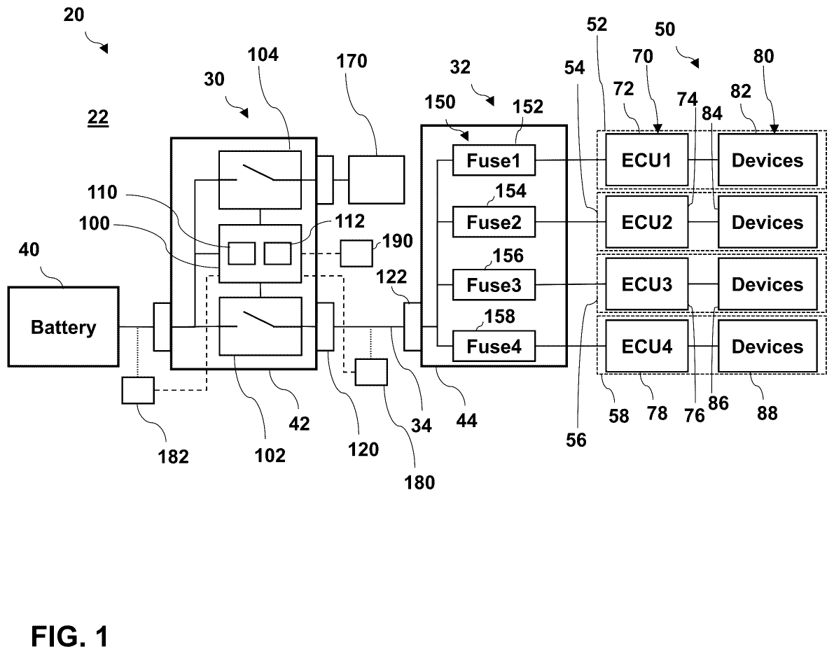

Referring to FIG. 1, an electrical assembly 20 includes a controller assembly 30, a fuse assembly 32, and a wire 34 electrically connecting the controller assembly 30 with the fuse assembly 32. The electrical assembly 20 is illustrated in a vehicle 22 but is not limited to vehicle applications. The controller assembly 30 is electrically connected with a battery 40, such as of the vehicle 22. The battery 40 is configured to provide an output voltage. The output voltage is optionally 12 V, 24 V, or 48V. Optionally, the controller assembly 30 includes a controller assembly housing 42, the fuse assembly 32 includes a fuse assembly housing 44 separate from the controller assembly housing 42, and the wire 34 extends from the controller assembly housing 42 to the fuse assembly housing 44.

The fuse assembly 32 is electrically connected with a plurality of loads 50, such as a first load 52, a second load 54, a third load 56, and/or a fourth load 58 of the vehicle 22. The plurality of loads 50 include respective electronic control units (ECUs) 70, such as a first ECU 72, a second ECU 74, a third ECU 76, and a fourth ECU 78, and electrical devices 80 connected to the ECUs 70, such as a first electrical device 82 connected to the first ECU 72, a second electrical device 84 connected to the second ECU 74, a third electrical device 86 connected to the third ECU 76, and a fourth electrical device 88 connected to the fourth ECU 78. Optionally, the electrical devices 80 comprise one or more vehicle electrical devices, such as seat motors, heaters, fans, lights, controllers, antennas, other devices, or combinations thereof.

The controller assembly 30 includes a controller 100 (e.g., an electronic controller), a first switch 102, and/or a second switch 104, some or all of which are electrically connected to the battery 40. The first switch 102 and/or the second switch 104 can include one or more of a variety of configurations, such as a transistor (e.g., a metal-oxide-semiconductor field-effect transistor (MOSFET)), a relay, a contactor, other switch configurations, or combinations thereof. The controller 100 includes a processor 110 and a memory 112, and is configured to control operation of (e.g., open and close) the first switch 102 and/or the second switch 104. For example, the controller 100 is electrically connected to the first switch 102 and the second switch 104. While illustrated with two switches, the controller assembly 30 can include a single switch or more than one switch. The first switch 102 is electrically connected to the fuse assembly 32, such as via the wire 34. Optionally, the wire 34 is electrically connected to the controller assembly 30 via a first connector 120 and/or is electrically connected to the fuse assembly 32 via a second connector 122. The first connector 120 is, for example, provided at or connected to an outer surface of the controller assembly housing 42. The second connector 122 is, for example, provided at or connected to an outer surface of the fuse assembly housing 44.

The fuse assembly 32 includes a plurality of fuses 150, such as a first fuse 152, a second fuse 154, a third fuse 156, and/or a fourth fuse 158. The plurality of fuses 150 include thermal fuses, for example, and can include the same or different current limits. The first fuse 152 is electrically connected to the first load 52, such as to limit current from the battery 40 provided to the first load 52. The second fuse 154 is electrically connected to the second load 54, such as to limit current from the battery 40 provided to the second load 54. The third fuse 156 is electrically connected to the third load 56, such as to limit current from the battery 40 provided to the third load 56. The fourth fuse 158 is electrically connected to the fourth load 58, such as to limit current from the battery 40 provided to the fourth load 58.

The second switch 104 is electrically connected to one or more other components 170, which optionally include a fuse assembly and loads. For example, the controller 100 can control, at least in part, operation of the plurality of loads 50 and additional loads, such as via respective switches (e.g., the first switch 102, the second switch 104).

The controller 100 is configured to monitor an electrical current in the wire 34, such as via a current sensor 180. The current sensor 180 can be connected to the wire 34 directly, can be incorporated into the controller assembly 30, and/or can be incorporated into the first switch 102. For example, the first switch 102 optionally includes an electronic fuse that monitors the current at the first switch 102, which is equal (or sufficiently close to equal) to the current in the wire 34. Monitoring the current in the wire 34 includes determining that the current exceeds a current threshold. For example, the controller 100 compares the current in the wire 34 to the current threshold. In accordance with determining that the current exceeds the current threshold, the controller 100 opens the first switch 102, such as to prevent damage to the wire 34.

The controller 100 is configured to monitor a voltage of the battery 40, such as via a voltage sensor 182. The voltage sensor 182 is a stand-alone sensor, integrated with the battery 40, and/or incorporated into the controller assembly 30, for example, and is in communication with the controller 100. The controller 100 monitors the voltage according to a first voltage threshold and a second voltage threshold that is lower than the first voltage threshold. With a 12 V battery, the first voltage threshold is 9 V and the second voltage threshold is 5.5 V, for example. Optionally, the first voltage threshold and the second voltage threshold are other values. The controller 100 is configured to provide undervoltage protection for the battery 40. For example, the controller 100 is configured to open the first switch 102 in accordance with determining that the voltage of the battery 40 is less than the first voltage threshold, at least in some circumstances, and open the first switch 102 in accordance with determining that the voltage of the battery 40 is at or less than the second voltage threshold.

The controller 100 is configured to determine whether the electrical assembly 20 is in a rectification state, such as via a rectification sensor 190 and/or an indication from the vehicle 22 (e.g., a different controller, a power management system, others). The rectification sensor 190 includes, for example, a park sensor of the vehicle 22 that provides an indication of the vehicle 22 being in park (e.g., with the parking brake set, with a transmission in park, being at a parking location, others) and/or a vehicle speed sensor that provides an indication that the vehicle 22 is not moving. For example, in the rectification state, the electrical assembly 20 and/or the vehicle 22 are in a condition in which disconnecting one or more of the loads 50, such as to rectify the condition of one or more fuses 150, does not present a safety hazard. The rectification state can vary according to the relevant load of the one or more loads 50. For less critical loads (e.g., infotainment, cabin heating, seat adjustment, others), the rectification state can be reached while the vehicle 22 is moving. For more critical loads (e.g., braking, steering, others), the rectification state can be reached when the vehicle 22 is stopped and/or in park.

In some circumstances, the current in the wire 34 could exceed the current threshold due to high current at one or more of the loads 50 (e.g., above the current limits of one or more of the fuses 150), such as due to a fault with the load 50 (e.g., a short circuit to ground). The controller 100 can operate the first switch 102 to open the circuit faster than the respective fuse(s) 150 melt. In such a situation, it may not be clear which load 50 is causing the high current, and/or the faulty load(s) may remain connected to the controller assembly 30 due to the un-melted fuse. The controller 100 is configured to operate the first switch 102 to cause the fuse(s) 150 connected to the load(s) 50 experiencing the high current to increase in temperature and, at least in some circumstance, to melt (e.g., to rectify the un-melted fuse). For example, the controller 100 is configured to initially open the first switch 102 in accordance with determining that the current in the wire 34 is above the current threshold and/or that the voltage at the battery 40 is below the first voltage threshold. Then, the controller 100 is configured to close (e.g., temporarily) the first switch 102 to increase a fuse temperature of at least one of the fuses 150 (e.g., the fuse(s) 150 connected to the faulty load(s) 50). For example, the controller 100 keeps the first switch 102 closed long enough to increase the fuse temperature and opens the first switch 102 again before the wire 34 is damaged. In some instances, the controller 100 repeatedly closes and opens the first switch 102 to progressively increase the fuse temperature of at least one of the fuses 150, such as if the first cycle of closing and opening the first switch 102 does not result in the at least one fuse 150 melting. The controller 100 repeats this closing and opening cycle to progressively increase the fuse temperature until the at least one fuse 150 is melted or a repeat threshold is met. The repeat threshold is a number of closing and opening cycles the controller 100 will conduct in attempting to melt the at least one fuse 150 before stopping and indicating an error. Optionally, the repeat threshold is at least 1 and less than or equal to 10, and/or can be configurable, such as according to a criticality of the corresponding load(s) 50. For example, the repeat threshold is, optionally, lower for safety critical loads and higher for less critical loads. The controller 100 detects that the at least one fuse has melted by, for example, determining that the current in the wire 34 remains below the current threshold with the first switch 102 closed and/or that communication with one or more ECUs 70 is not available (e.g., the melted fuse disconnects the ECU from the battery 40). In some instances, a single closing and opening cycle is sufficient to melt the fuse 150.

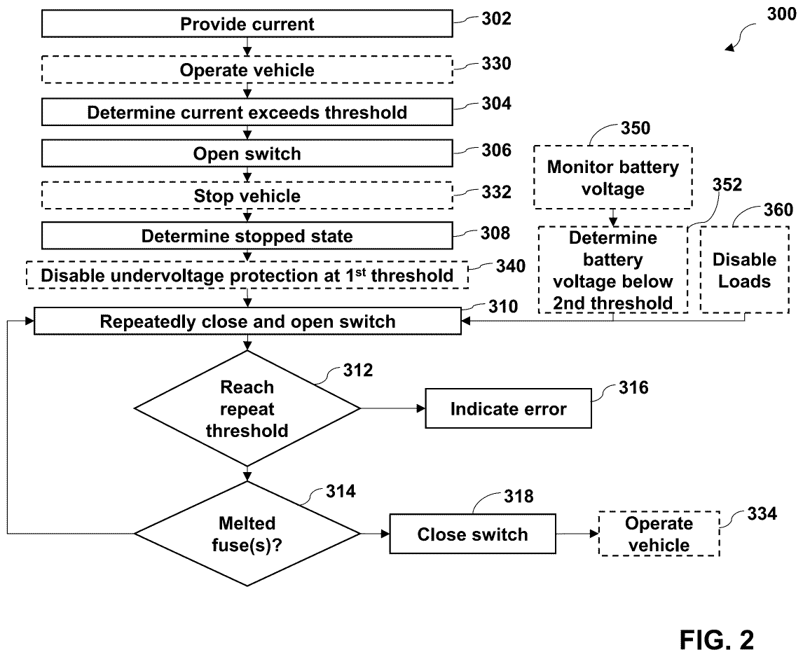

Referring to FIG. 2, a method 300 of operating an electrical assembly is illustrated that can, for example, be utilized in connection with the electrical assembly 20 and/or the vehicle 22 illustrated in FIG. 1. The method 300 includes providing electrical current from the battery 40 through the controller assembly 30 (e.g., through the first switch 102), the wire 34, and the fuse assembly 32 to the plurality of loads 50 (block 302). Providing the electrical current through the controller assembly 30 includes the controller 100 closing the first switch 102 to electrically connect the fuse assembly 32 with the battery 40 via the wire 34. The method 300 includes the controller assembly 30 (e.g., the controller 100) determining the current in the wire 34 exceeds the current threshold (block 304) and opening the first switch 102 in accordance with determining that the current exceeds the current threshold (block 306), such as to prevent damage to the wire 34.

The method 300 includes determining that the electrical assembly 20 is in a rectification state (block 308), such as via the rectification sensor 190. The method 300 includes repeatedly closing and opening the first switch 102 (block 310), such as to progressively increase the fuse temperature of at least one fuse of the plurality of fuses 150, in accordance with determining that the electrical assembly 20 is in the rectification state in block 308 and that the current exceeds the current threshold in block 304. The first switch 102 is closed long enough to increase the fuse temperature while not damaging the wire 34, and is open a short enough period of time that cooling of the fuse(s) is limited (e.g., negligible). Increasing the fuse temperature in block 310 can include, for example, causing the at least one fuse 150 (e.g., at least one thermal fuses) to melt, such as to disconnect a faulty load (e.g., the load(s) 50 connected to the melted fuse(s)). In some cases, such as with the first load 52 and the second load 54 both being faulty, melting the at least one fuse 150 includes melting the first fuse 152 (e.g., a first thermal fuse) and the second fuse 154 (e.g., a second thermal fuse) to disconnect the first load 52 and the second load 54 from the battery 40. The method 300 includes detecting the repeat threshold is reached (block 312) or one or more fuses have melted (block 314). Detecting the repeat threshold is reached in block 312 can include the controller 100 counting the number of times the first switch 102 has been closed and opened, and comparing that number to the repeat threshold. In accordance with detecting the repeat threshold is reached in block 312, the method 300 includes the controller 100 providing an indication of an error (block 316), such as a warning message to a driver. In accordance with detecting one or more fuses have melted, such as via monitoring the current in the wire 34 during the closing and opening in block 310, the method 300 includes the controller 100 closing the first switch 102 (block 318), such as to allow normal operation of the loads 50 not connected to the melted fuse(s).

Optionally, the method 300 includes operating the vehicle 22 while providing the current in block 302 (block 330), stopping the vehicle 22 after detecting that the current exceeds the current threshold in block 304 (block 332), and/or operating the vehicle 22 after closing the first switch 102 in block 318 (block 334). Operating the vehicle 22 in block 330 includes, for example, operating the vehicle 22 to move a first distance. Operating the vehicle 22 in block 334 includes, for example, operating the vehicle 22 to move a second distance.

Optionally, the method 300 includes disabling undervoltage protection for the battery 40 at the first voltage level (block 340), such as during the closing and opening of block 310. For example, the controller 100 allows the battery voltage to decrease below the first voltage threshold while repeatedly opening and closing and opening the first switch 102 in block 310.

Optionally, the controller 100 maintains undervoltage protection at the second voltage threshold even with undervoltage protection at the first voltage threshold disabled. For example, the method 300 includes monitoring the battery voltage while repeatedly closing and opening the first switch 102 in block 310 (block 350), and determining that the battery voltage is at or below the second voltage threshold (block 352). In accordance with determining the battery voltage, the controller 100 opens the first switch 102 as part of repeatedly closing and opening the first switch 102 in block 310. For example, block 310 optionally includes the controller 100 keeping the first switch 102 open for a battery recovery period to allow the battery voltage to exceed the second voltage threshold and/or reach the first voltage threshold, and then continuing with closing and opening the first switch 102. The battery recovery period is, for example and without limitation, 6.5 to 500 microseconds.

Optionally, the method 300 includes disabling one or more loads 50, such as one or more of the ECUs 70, and/or the additional loads connected to the second switch 104, while closing and opening the first switch 102 in block 310 (block 360), which can increase the amount of current provided to other fuses of the fuse assembly 32. For example, the controller 100 can disable the second ECU 74 to increase the amount of current provided to the first fuse 152 to facilitate melting of the first fuse 152. The controller 100 can disable ECUs 70 that are known to be operating properly and/or can cycle through disabling the ECUs 70 to facilitate identifying a faulty load 50. Additionally or alternatively, the controller 100 can open the second switch 104 to increase current provided to the fuse assembly 32.

Some or all of the blocks of the method 300 can be conducted, at least in part, via the controller assembly 30, such as via the controller 100.

The instant disclosure includes the following non-limiting embodiments:

An electrical assembly, comprising: a controller assembly, including: a switch, and an electronic controller electrically connected to the switch; a fuse assembly including a plurality of thermal fuses electrically connectable to a plurality of loads; and a wire electrically connecting the controller assembly with the fuse assembly; wherein the electronic controller is configured to: determine that a current in the wire exceeds a current threshold; determine that a battery voltage is at or below a first voltage threshold; open the switch in accordance with determining that at least one of (i) the current exceeds the current threshold, or (ii) the battery voltage is at or below the first voltage threshold; and close and open the switch to increase a fuse temperature of at least one thermal fuse of the plurality of thermal fuses.

An electrical assembly, comprising: a controller assembly, including: a switch, and an electronic controller electrically connected to the switch; a fuse assembly including a plurality of thermal fuses electrically connectable to a plurality of loads; and a wire electrically connecting the controller assembly with the fuse assembly; wherein the electronic controller is configured to: determine that a current in the wire exceeds a current threshold; determine that a battery voltage is at or below a first voltage threshold; open the switch in accordance with determining that at least one of (i) the current exceeds the current threshold, or (ii) the battery voltage is at or below the first voltage threshold; and repeatedly close and open the switch to progressively increase a fuse temperature of at least one thermal fuse of the plurality of thermal fuses.

The electrical assembly of any preceding embodiment, wherein the electronic controller is configured to determine that the electrical assembly is in a rectification state; the electronic controller is configured to repeatedly close and open the switch after determining the electrical assembly is in the rectification state.

The electrical assembly of any preceding embodiment, further comprising a rectification sensor configured to indicate the electrical assembly is in the rectification state.

The electrical assembly of any preceding embodiment, wherein the rectification sensor comprises at least one of a park sensor or a speed sensor of a vehicle.

The electrical assembly of any preceding embodiment, wherein the plurality of thermal fuses includes a first thermal fuse, a second thermal fuse, a third thermal fuse, and a fourth thermal fuse.

The electrical assembly of any preceding embodiment, wherein the at least one thermal fuse of the plurality of thermal fuses includes the first thermal fuse and the third thermal fuse.

The electrical assembly of any preceding embodiment, wherein the electronic controller is configured to increase the fuse temperature to cause the at least one thermal fuse of the plurality of thermal fuses to melt.

The electrical assembly of any preceding embodiment, wherein the electronic controller is configured to repeatedly close and open the switch until the at least one thermal fuse melts or a repeat threshold is met.

The electrical assembly of any preceding embodiment, wherein the switch comprises a transistor; the controller assembly includes a controller assembly housing; the fuse assembly includes a fuse assembly housing separate from the controller assembly housing; and the wire extends from the controller assembly housing to the fuse assembly housing.

A vehicle, comprising: the electrical assembly of any preceding embodiment; a battery electrically connected to the controller assembly; and the plurality of loads electrically connected to the fuse assembly.

The vehicle of any preceding embodiment, wherein a first load of the plurality of loads includes a vehicle electrical device and a first electronic control unit (ECU) electrically connected to the fuse assembly and the vehicle electrical device to control, at least in part, operation of the vehicle electrical device.

The vehicle of any preceding embodiment, wherein the vehicle electrical device comprises at least one of a light, a seat motor, an electric heater, or an antenna.

A method of operating the electrical assembly or the vehicle of any preceding embodiment, the method comprising: providing current from a battery through the switch, the wire, and the fuse assembly to the plurality of loads; determining the current exceeds the current threshold; opening the switch in accordance with determining that the current exceeds the current threshold; determining the electrical assembly is in a rectification state; and repeatedly closing and opening the switch to progressively increase the fuse temperature of the at least one thermal fuse of the plurality of thermal fuses in accordance with determining the electrical assembly is in the rectification state.

The method of any preceding embodiment, further comprising disabling undervoltage protection for the battery at the first voltage threshold.

The method of any preceding embodiment, further comprising: monitoring the battery voltage while repeatedly closing and opening the switch; and determining the battery voltage is at or below a second voltage threshold that is lower than the first voltage threshold; wherein repeatedly closing and opening the switch includes opening the switch for a battery recovery period after determining the battery voltage is at or below the second voltage threshold.

The method of any preceding embodiment, further comprising monitoring the current while repeatedly closing and opening the switch.

The method of any preceding embodiment, wherein repeatedly closing and opening the switch includes causing a first thermal fuse and a second thermal fuse of the plurality of thermal fuses to melt.

The method of any preceding embodiment, wherein repeatedly closing and opening the switch continues until the current is at or below the current threshold with the switch closed or a repeat threshold is reached.

The method of any preceding embodiment, wherein the plurality of thermal fuses includes a first thermal fuse and a second thermal fuse; the plurality of loads includes a first load electrically connected to the first thermal fuse, and a second load electrically connected to the second thermal fuse; the first load includes a first electronic control unit (ECU) and a first electrical device controlled by the first ECU; the second load includes a second ECU and a second electrical device controlled by the second ECU; and the method further comprises disabling the second ECU while repeatedly closing and opening the switch to increase current flow through the first thermal fuse to facilitate melting of the first thermal fuse.

The method of any preceding embodiment, further comprising: operating a vehicle to move a first distance, the vehicle including the electrical assembly; stopping the vehicle, after opening the switch in accordance with determining that the current exceeds the current threshold, to transition the electrical assembly to the rectification state; melting the at least one thermal fuse via the repeatedly closing and opening the switch; and operating the vehicle to move a second distance after melting the at least one thermal fuse.

A vehicle comprising the assembly of any preceding embodiment.

An electronic controller configured to implement the method of any preceding embodiment.

A vehicle comprising the electronic controller of any preceding embodiment.

A non-transitory computer-readable storage medium having a computer program encoded thereon for implementing the method of any preceding embodiment.

A vehicle comprising the non-transitory computer-readable storage medium of any preceding embodiment.

In examples, a controller (e.g., the controller 100, the ECUs 70) may include an electronic controller and/or include an electronic processor, such as a programmable microprocessor and/or microcontroller. In embodiments, a controller may include, for example, an application specific integrated circuit (ASIC) and/or an embedded controller. A controller may include a central processing unit (CPU), a memory (e.g., a non-transitory computer-readable storage medium), and/or an input/output (I/O) interface. A controller may be configured to perform various functions, including those described in greater detail herein, with appropriate programming instructions and/or code embodied in software, hardware, and/or other medium. In embodiments, a controller may include a plurality of controllers. In embodiments, a controller may be connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “in the illustrated example,” “various embodiments,” “with embodiments,” “in embodiments,” “an embodiment,” “with some configurations,” “in some configurations,” or the like, means that a particular feature, structure, or characteristic described in connection with the example/embodiment is included in at least one embodiment. Thus, appearances of the phrases “examples, “in examples,” “with examples,” “in the illustrated example,” “in various embodiments,” “with embodiments,” “in embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof. The word “exemplary” is used herein to mean “serving as a non-limiting example.”

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “at least one of” in the context of, e.g., “at least one of A, B, and C” or “at least one of A, B, or C” includes only A, only B, only C, or any combination or subset of A, B, and C, including any combination or subset of one or a plurality of A, one or a plurality of B, and one or a plurality of C. A “set” of elements can include any number of one or more elements.

Although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. The term “and/or” as used herein refers to and encompasses any and all possible combinations of one or more of the associated listed items. Uses of “and” and “or” are to be construed broadly (e.g., to be treated as “and/or”). For example and without limitation, uses of “and” do not necessarily require all elements or features listed, and uses of “or” are inclusive unless such a construction would be illogical. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

References to a vehicle can include one or more of a variety of vehicles, including, without limitation, a passenger car (e.g., a sedan, a pickup truck, a sport utility vehicle, a crossover, etc.), a recreational vehicle, a truck, a bus, a plane, or a boat, among others.

All matter contained in the above description or shown in the accompanying drawings shall be interpreted as illustrative only and not limiting. Changes in detail or structure may be made without departing from the present disclosure.

A controller, an electronic control unit (ECU), an electronic controller a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

An article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. An electrical assembly, comprising:
a controller assembly, including:
a switch, and
an electronic controller electrically connected to the switch;
a fuse assembly including a plurality of thermal fuses electrically connectable to a plurality of loads; and
a wire electrically connecting the controller assembly with the fuse assembly;
wherein the electronic controller is configured to:
determine that a current in the wire exceeds a current threshold;
determine that a battery voltage is at or below a first voltage threshold;
open the switch in accordance with determining that at least one of (i) the current exceeds the current threshold, or (ii) the battery voltage is at or below the first voltage threshold; and
repeatedly close and open the switch to progressively increase a fuse temperature of at least one thermal fuse of the plurality of thermal fuses.

2. The electrical assembly of claim 1, wherein the electronic controller is configured to determine that the electrical assembly is in a rectification state; and
the electronic controller is configured to repeatedly close and open the switch after determining the electrical assembly is in the rectification state.

3. The electrical assembly of claim 2, further comprising a rectification sensor configured to indicate the electrical assembly is in the rectification state.

4. The electrical assembly of claim 3, wherein the rectification sensor comprises at least one of a park sensor or a speed sensor of a vehicle.

5. The electrical assembly of claim 1, wherein the plurality of thermal fuses includes a first thermal fuse, a second thermal fuse, a third thermal fuse, and a fourth thermal fuse.

6. The electrical assembly of claim 5, wherein the at least one thermal fuse of the plurality of thermal fuses includes the first thermal fuse and the third thermal fuse.

7. The electrical assembly of claim 1, wherein the electronic controller is configured to increase the fuse temperature to cause the at least one thermal fuse of the plurality of thermal fuses to melt.

8. The electrical assembly of claim 1, wherein the electronic controller is configured to repeatedly close and open the switch until the at least one thermal fuse melts or a repeat threshold is met.

9. The electrical assembly of claim 1, wherein the switch comprises a transistor;
the controller assembly includes a controller assembly housing;
the fuse assembly includes a fuse assembly housing separate from the controller assembly housing; and
the wire extends from the controller assembly housing to the fuse assembly housing.

10. A vehicle, comprising:
the electrical assembly of claim 1;
a battery electrically connected to the controller assembly; and
the plurality of loads electrically connected to the fuse assembly.

11. The vehicle of claim 10, wherein a first load of the plurality of loads includes a vehicle electrical device and a first electronic control unit (ECU) electrically connected to the fuse assembly and the vehicle electrical device to control, at least in part, operation of the vehicle electrical device.

12. The vehicle of claim 11, wherein the vehicle electrical device comprises at least one of a light, a seat motor, an electric heater, or an antenna.

13. A method of operating the electrical assembly of claim 1, the method comprising:
providing current from a battery through the switch, the wire, and the fuse assembly to the plurality of loads;
determining the current exceeds the current threshold;
opening the switch in accordance with determining that the current exceeds the current threshold;
determining the electrical assembly is in a rectification state; and
repeatedly closing and opening the switch to progressively increase the fuse temperature of the at least one thermal fuse of the plurality of thermal fuses in accordance with determining the electrical assembly is in the rectification state.

14. The method of claim 13, further comprising disabling undervoltage protection for the battery at the first voltage threshold.

15. The method of claim 14, further comprising:
monitoring the battery voltage while repeatedly closing and opening the switch; and
determining the battery voltage is at or below a second voltage threshold that is lower than the first voltage threshold;
wherein repeatedly closing and opening the switch includes opening the switch for a battery recovery period after determining the battery voltage is at or below the second voltage threshold.

16. The method of claim 15, further comprising monitoring the current while repeatedly closing and opening the switch.

17. The method of claim 12, wherein repeatedly closing and opening the switch includes causing a first thermal fuse and a second thermal fuse of the plurality of thermal fuses to melt.

18. The method of claim 12, wherein repeatedly closing and opening the switch continues until the current is at or below the current threshold with the switch closed or a repeat threshold is reached.

19. The method of claim 13, wherein the plurality of thermal fuses includes a first thermal fuse and a second thermal fuse;
the plurality of loads includes a first load electrically connected to the first thermal fuse, and a second load electrically connected to the second thermal fuse;
the first load includes a first electronic control unit (ECU) and a first electrical device controlled by the first ECU;
the second load includes a second ECU and a second electrical device controlled by the second ECU; and
the method further comprises disabling the second ECU while repeatedly closing and opening the switch to increase current flow through the first thermal fuse to facilitate melting of the first thermal fuse.

20. The method of claim 13, further comprising:
operating a vehicle to move a first distance, the vehicle including the electrical assembly;
stopping the vehicle, after opening the switch in accordance with determining that the current exceeds the current threshold, to transition the electrical assembly to the rectification state;
melting the at least one thermal fuse via the repeatedly closing and opening the switch; and
operating the vehicle to move a second distance after melting the at least one thermal fuse.
